(19) United States
(12) Patent Application Publication
(10) Pub. No.: US 2005/0097010 A1
(43) Pub. Date: May 5, 2005

(54) System and method for remote inventory management

(75) Inventor: Curtis Lee Carrender, Morgan HIll, CA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Battelle Memorial Institute, Richland, WA (US)

(21) Appl. No.: 10/698,224

(22) Filed: Oct. 31, 2003

(51) Int. Cl. G06F 17/60

(52) U.S. Cl. 705/28

(57) ABSTRACT

A system for inventorying remote objects and management of assets, the system including a plurality of radio frequency tags associated with a respective object; at least one reader configured to interrogate the tags with radio frequency identification signals to receive data from the tags in response to command and control signals; and a remote device coupled to the Internet and configured to transmit command and control signals via the Internet to the reader and to receive from the reader data uploaded to the Internet that is received from the tags via the reader.

### STATEMENT REGARDING FEDERALLY SPONSORED RESEARCH OR DEVELOPMENT

This invention was made with U.S. Government support under Contract DE-AC0676RLO1830 awarded by the U.S. Department of Energy. The U.S. Government has certain rights in the invention.

### BACKGROUND OF THE INVENTION

1. Field of the Invention

The present invention pertains to inventory assessment, and more particularly to the use of web-based tools for performing a radio frequency identification inventorying of assets.

2. Description of the Related Art

The manufacture and marketing of products in commerce involves the storage and tracking of raw goods and the finished products at the place of manufacture and in the channels of distribution. Effective and efficient management of these assets requires timely and accurate information as to the status of these assets.

Inventory management and control has been facilitated in recent years by the use of wireless communication wherein large stores of goods, both in bulk and in discrete packaging, can be rapidly inventoried and tracked. One form of wireless communication that has become economically and technically feasible in this area is radio frequency identification (RFID).

RF identification (RFID) tag systems have been developed to facilitate monitoring of remote objects. As shown in FIG. 1, a basic RFID system 10 consists of three components, an antenna 12 or coil, a transceiver with decoder 14, and a transponder (commonly called an RF tag) 16. In operation, the antenna 12 emits electromagnetic radio signals generated by the transceiver 14 to activate the tag 16. When the tag 16 is activated, data can be read from or written to the tag.

In some applications, the antenna 12 is a component of the transceiver and decoder 14 to become an interrogator (or reader) 18, which can be configured either as a hand held or a fixed-mount device. The interrogator 18 emits the radio signals 20 in range from one inch to one hundred feet or more, depending upon its power output and the radio frequency used. When an RF tag 16 passes through the electromagnetic radio waves 20, the tag 16 detects the signal 20 and is activated. Data encoded in the tag 16 is then transmitted by a data signal 22 through an antenna 24 to the interrogator 18 for subsequent processing.

An advantage of RFID systems is the non-contact, non-line-of-sight capability of the technology. Tags can be read through a variety of substances such as snow, fog, ice, paint, dirt, and other visually and environmentally challenging conditions where bar codes or other optically-read technologies would be useless. RF tags can also be read at remarkable speeds, in most cases responding in less than one hundred milliseconds.

There are three main categories of RFID tags. These are beam-powered passive tags, battery-powered semi-passive tags, and active tags. Each operate in fundamentally different ways.

The beam-powered RFID tag is often referred to as a passive device because it derives the energy needed for its operation from the radio frequency energy beamed at it. The tag rectifies the field and changes the reflective characteristics of the tag itself, creating a change in reflectivity based upon data in the tag that is seen at the interrogator. A battery-powered semi-passive RFID tag operates in a similar fashion, modulating its RF cross section in order to reflect a delta to the interrogator to develop a communication link. Here, the battery is the source of the tag's operational power. Finally, in the active RFID tag, a transmitter is used to create its own radio frequency energy powered by the battery.

A typical RF tag system 10 will contain at least one tag 16 and one interrogator 18. The range of communication for such tags varies according to the transmission power of the interrogator 18 and the tag 16. The range will be dependent upon the type of system, the power, and the frequency of operation. Conventional RF tag systems utilize continuous wave backscatter to communicate data from the tag 16 to the interrogator 18. More specifically, the interrogator 18 transmits a continuous-wave radio signal to the tag 16, which modulates the signal 20 using modulated backscatter wherein the electrical characteristics of the antenna 20 are altered by a modulating signal in the tag that reflects a modulated signal 22 back to the interrogator 18. The modulated signal 22 is encoded with information from the tag 16. The interrogator 18 then demodulates the modulated signal 22 and decodes the information.

Operational control of the interrogator is generally done on site. While remote control is possible, it is desirable to provide not only control for the interrogator but means for obtaining data from the interrogator to be processed remotely, such as at a facility located in another state or even in another country.

The use of a worldwide network of computers for the sharing of data has evolved into the Internet, which has facilitated not only the dissemination of information but a new method of conducting commerce. Goods and services are becoming more readily available on the Internet, and it is now possible to communicate and transact business throughout the world. Transactional information is readily exchanged via this medium.

In U.S. Pat. No. 6,509,828 a method is disclosed for interrogating tags on multiple frequencies and synchronizing databases using transferable agents. An interrogator is provided that communicates with RF tags on multiple frequencies and bandwidths to track assets from different manufacturers. A logistics server communicates With the interrogators via an Internet connection. Information about an associated asset is transmitted from the one or more active tags. While useful for its purpose, this system does not address the use of passive tags and does not disclose how client control of the interrogators is performed.

### BRIEF SUMMARY OF THE INVENTION

The disclosed and claimed embodiments of the invention are directed to a system and method for inventorying remote objects and management of such objects. In one embodiment, the system includes a plurality of passive tags, each tag associated with a respective object; a reader configured to interrogate the passive tags and to receive data therefrom; and a device for coupling the reader to the Internet to enable the reader to receive control and command signals via the Internet and for the reader to upload the data to the Internet that is received from the passive tags.

In accordance with another embodiment of the invention, a system for management of remote assets is provided that includes a plurality of passive tags, each tag associated with a respective asset; a reader configured to interrogate the passive tags and to receive data therefrom regarding the associated asset; a device for coupling the reader to the Internet to enable the reader to receive control and command signals via the Internet and for the reader to upload the data from the passive tags to the Internet; and a remote device coupled to the Internet and configured to transmit control and command signals via the Internet to the reader and to receive and process the data from the reader.

In accordance with yet another embodiment of the invention, a method of managing remote assets is provided that includes providing a plurality of tags, each tag associated with a respective asset; issuing commands from a device coupled to the Internet to a reader that is also coupled to the Internet to transmit radio frequency interrogation signals from the reader to the plurality of tags; receiving at the reader data from the plurality of tags in response to the radio frequency interrogation signals; and transferring the data from the reader to the Internet. The data is then received at a device coupled to the Internet and which is configured to process the received data.

As will be readily appreciated from the foregoing, the system and method disclosed herein utilizes passive tags, which eliminates the need to provide external or internal power to the tags. This enables the use of inexpensive tags that can be associated with bulk goods, and it enables efficient tracking of the goods not only while in storage but during the manufacturing process and subsequent distribution. Command and control of the reader can be accomplished from any location throughout the world via a connection to the Internet. Similarly, data can be received at the point of initiation of the command or sent to any other remote location for processing. Tracking and management of raw goods and finished products can be accomplished utilizing existing computer hardware and Internet connections.

### BRIEF DESCRIPTION OF THE SEVERAL VIEWS OF THE DRAWING(S)

The foregoing advantages and features of the present invention will be more readily appreciated as the same become better understood when taken in conjunction with the following drawings, wherein:

FIG. 1 is a schematic illustrating a known radio frequency identification system;

FIG. 2 is a schematic illustrating one embodiment of a system for remote management of assets.

### DETAILED DESCRIPTION OF THE INVENTION

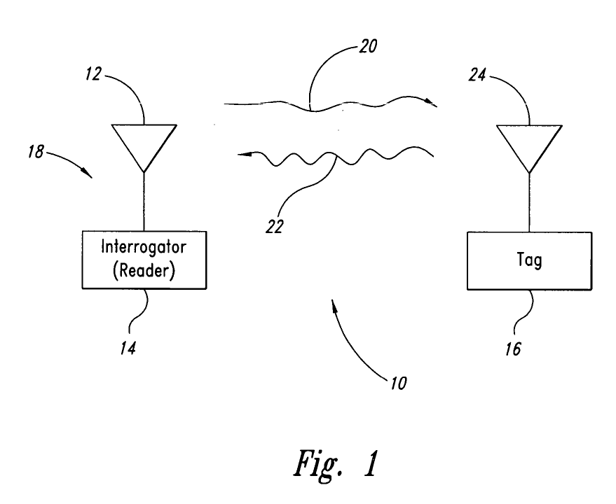

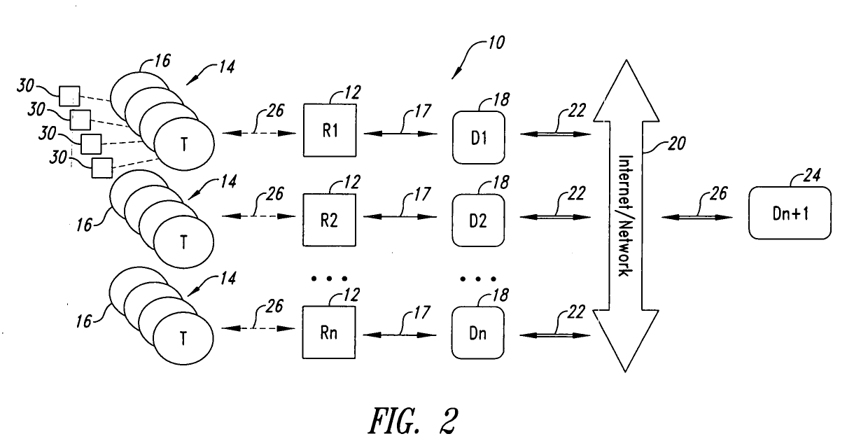

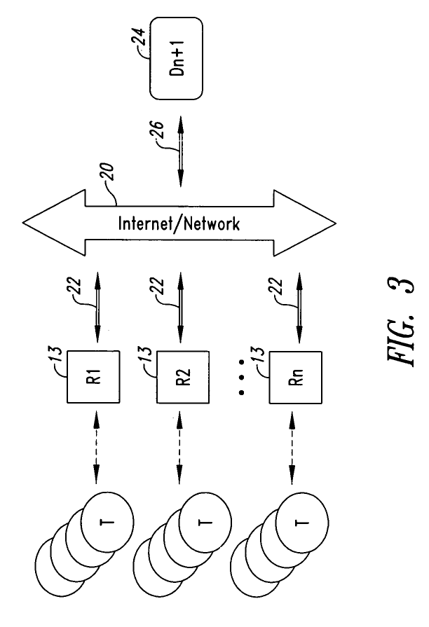

Referring initially to FIG. 2, shown therein is a diagram of one embodiment of a remote inventory management system 10 formed in accordance with the present invention. In this system 10, a plurality of interrogators or readers 12 are each configured to be in radio communication with a respective group 14 of tags 16. The readers 12 and tags 16 communicate via conventional radio frequency identification techniques previously described in connection with FIG. 1.

Each reader 12 is coupled to a communication device 18 via a local connectivity device 17 that is configured to provide connectivity to a communication network 20 through a standard network communication link 22. Ideally, the communication device 18 provides two-way connectivity to the communication network 20, although one-way communication could be used if desired. The network 20 is preferably the internet, although in addition or in the alternative, the device 17 can be configured to couple the reader 12 to an intranet, local area network, or other communication network for the transmission of information obtained from the reader 12 and the reception of command and control signals from a remote device or devices 24 coupled to the Internet 20 via a network link 26.

In a preferred embodiment, each tag 16 is a passive device that responds to an interrogation signal 26 transmitted by one or more of the readers 12. In the depicted embodiment, each tag 16 is associated with a single reader 12, and each reader 12 is coupled to the network 22 via the local connectivity device 17. However, as shown in FIG. 3, a reader 13 having inherent Internet connectivity is coupled directly to the network 20 via the network communication link 22. In this embodiment, having the reader 13 configured to connect directly to the network 20 avoids the need for two devices and an additional communication link.

The tag 16 is associated with a single object 30, and it is configured to store information regarding the object 30, including, but not limited to, identification, location, origin, destination, contents, status such as environmental conditions, security, position, as well as recipient information. The tag 16 may be physically attached to the object, packaged with the object, or associated with packaging for the object 30.

In the embodiments shown in FIGS. 2 and 3, the remote device 24 is configured to provide command and control signals to the readers 12, 13 and to receive data and information signals from the readers 12, 13. Input from a user regarding control and operation of the system 10 and its components is received via standard input devices, such as keyboard, mouse, joystick, touch screen, and voice, as well as other input devices including sensors, eye mouse, and the like that is well known to those skilled in the art. Input from a user regarding control and operation of the system 10 and its components can also be obtained from a set of rules resident in a database. These rules might, as an example, reroute items automatically based upon information from their tags. Output to a user is also by conventional devices, including print, screen, and audio devices, as well as to a database.

The interface between the reader 12 and the network 20, whether a discrete device or one integrated with the reader 12, can be configured to utilize a variety of networking protocols, including, but not limited to, the following: TCP/IP, HTTP, HTTP's, FTP, and other protocols, including Telnet.

The system 10 is preferably configured to enable real-time inventorying of the remote objects 30 in an efficient and economical manner. For example, a store manager attempting to locate a particular item in inventory within the store can quickly connect to the store's local network, either from a desktop PC, workstation, or via a wireless device, such as a laptop or handheld computer. Command and control signals sent through the network are received at individual readers in the location where the inventory is stored. Individual readers may be selected or a group of readers utilized to interrogate the tags associated with the objects. Responses from the tags are received in real time and transmitted back through the network to the user, in this case the manager, who can survey the results almost instantaneously. A search for specific objects can also be conducted via readers configured to transmit a predetermined protocol to locate tags associated with the desired objects. Additionally, system rules may be in place to automatically do operations on the web based on sensing a particular tag, a particular type of data in a tag, or a particular class of item or tag that is attached to the item. This might entail notifying a store manager when some perishable was near its due date or alerting an individual or system when a particular special interest item had been “seen” by the network-enabled readers.

The system 10 is also contemplated for use via the Internet wherein stores and warehouses geographically remote from the location of the user may all be simultaneously or sequentially inventoried. While using the Internet, known security systems can be implemented to protect the information being transmitted thereon and to prevent unauthorized access to the system 10.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system for inventorying remote objects, comprising:
a plurality of passive tags, each tag associated with a respective object;
a reader configured to interrogate the passive tags with radio frequency identification signals and to receive data from the tags in response thereto; and
means for coupling the reader to the Internet to enable the reader to receive control signals via the Internet and to enable the reader to upload the data received from the tags to the Internet.

2. The system of claim 1, wherein the coupling means comprises a local connectivity system including a connectivity device and interconnectivity links.

3. The system of claim 1, wherein the means for coupling the reader to the Internet comprises a communication protocol integrated into the reader.

4. The system of claim 1, wherein the coupling means comprises wireless communication.

5. The system of claim 1, wherein the reader is configured to respond to command and control signals received via the Internet only from authorized sources.

6. An arrangement for monitoring remote inventory, comprising:
a plurality of passive tags, each tag associated with a respective object; a plurality of readers configured to interrogate the passive tags using radio frequency signals and to receive data therefrom; a device for coupling the readers to a network to enable the readers to receive control and command signals via the Internet and for the readers to upload the data to the network that is received from the passive tags.

7. The arrangement of claim 6, wherein the network comprises one from among a local area network and the Internet.

8. The arrangement of claim 6, wherein each of the plurality of readers are associated with a predetermined group of the passive tags.

9. The arrangement of claim 6, wherein the readers are configured to receive command and control signals from only an authorized source.

10. The arrangement of claim 6, further comprising at least one remote device configured to be coupled to the network for sending command and control signals to the readers via the network and to receive data uploaded from the readers to the network.

11. A system for management of remote assets, comprising: a plurality of tags, each tag associated with a respective asset; at least one reader configured to interrogate the tags and to receive data therefrom regarding the associated assets; a device for coupling the at least one reader to the Internet to enable the at least one reader to receive control and command signals via the Internet and for the at least one reader to upload the data from the tags to the Internet; and a remote device coupled to the Internet and configured to transmit control and command signals via the Internet to the at least one reader and receive and process the data from the at least one reader.

12. The system of claim 11, wherein each at least one reader is integrally formed with the device for coupling the at least one reader to the Internet.

13. The system of claim 12, wherein the at least one reader comprises a plurality of readers each having the coupling device integrally formed therewith.

14. The system of claim 13, wherein each reader is configured to communicate with a predetermined group of tags.

15. The system of claim 13, wherein the device for coupling the reader to the Internet comprises a wireless communication device that couples the reader to the Internet via radio frequency communication.

16. The system of claim 13, wherein each reader is configured to receive only authorized command and control signals.

17. A method of managing remote assets, comprising: providing a plurality of tags, each tag associated with a respective asset; issuing commands from a device coupled to the Internet to a reader coupled to the Internet to transmit radio frequency interrogation signals from the reader to the plurality of tags; receiving at the reader data from the plurality of tags in response to the radio frequency interrogation signals; transferring the data from the reader to the Internet; receiving the data at the device coupled to the Internet; and processing the received data.

18. The method of claim 17, wherein the reader is configured to receive only authorized command and control signals via the Internet.

19. The method of claim 17, further comprising providing a plurality of readers, each reader associated with a predetermined group of tags.

20. The method of claim 19, wherein providing a plurality of readers comprises configuring each of the plurality of readers to be directly connected to the Internet via an integrally formed interconnectivity device.
